(19) United States
(12) Patent Application Publication
(10) Pub. No.: US 2025/0166027 A1
(43) Pub. Date: May 22, 2025

(54) Method and System for Feedback Management and Search

(71) Applicant: Khaled M. SHAHRIAR, New Hyde Park, NY (US)

(72) Inventor: Khaled M. SHAHRIAR, New Hyde Park, NY (US)

(21) Appl. No.: 18/906,055

(22) Filed: Oct. 3, 2024

Related U.S. Application Data
(60) Provisional application No. 63/587,680, filed on Oct. 3, 2023.

(51) Int. Cl. G06Q 30/0282; G06F 16/29

(52) U.S. Cl. CPC G06Q 30/0282; G06F 16/29

(57) ABSTRACT

A computer system and computer-implemented method is provided for management of user feedback. Each user feedback includes location and temporal information of the feedback. A user can search via a user interface on a computing device from a collection of feedbacks in a search area defined by the user. As a result, one or more feedbacks responsive to the user query are searched and retrieved, and are presented on the user interface.

### BACKGROUND

In today's fast-paced and experience-driven world, people constantly encounter new and exciting things-whether it's savoring an exquisite dish, discovering a hidden gem of a place, or being captivated by nature's beauty. These experiences often get shared within the confines of personal social media circles, leaving much of this invaluable information out of reach for others who aren't in that network. Imagine the opportunities missed-a chance detour that could have led to a cherished memory, or a restaurant experience that could have delighted, but went undiscovered.

When people search for places to eat, things to do, or sights to see, they typically rely on traditional search engines or apps. However, these searches are often cumbersome and filled with incomplete or outdated results, requiring users to sift through irrelevant information. This can be frustrating, making it difficult to quickly find the most up-to-date and valuable recommendations.

People don't just want to read old reviews-they want real-time insights. For example, someone may witness a breathtaking view or indulge in a delightful dish and feel compelled to share that moment with others in the same area who are looking for similar experiences. Yet, while social media serves as a platform for sharing, it isn't structured in a way that allows others to efficiently discover and benefit from these spontaneous experiences. As a result, incredible opportunities for exploration and enjoyment slip by unnoticed.

Take food searches as an example: when users search for nearby dining options, they're often presented with restaurant menus or reviews that are outdated and no longer reflect current offerings. This disconnect between static, archived data and dynamic, real-time experiences leaves people guessing rather than making informed decisions.

Therefore, there is a need for a more dynamic and organized way to share and discover real-time feedback about local experiences, ensuring that valuable opportunities are not missed

### SUMMARY OF THE INVENTION

In one aspect, a computer-implemented method is provided, which comprises: providing or obtaining a collection of feedbacks, each feedback including or tagged with a geographical location and a time of creation; receiving, at a computing device (which can be geolocation-enabled), a user query to search feedbacks having geographical locations falling within a defined geographical search area and having time of creation that meets a recency criteria; determining, using at least one computer processor, one or more feedbacks in the collection of feedbacks that are responsive to the user query; and displaying the determined one or more responsive feedbacks on a user interface of the computing device.

In some embodiments, the computing device includes a user interface comprising a map view, and the geographical search area is selected by the user on the map view. The location information of the one or more determined responsive feedbacks can also be displayed on the map view.

In some embodiments, the geographical search area is determined based on a current location of the computing device.

In some embodiments, the location of each feedback of the collection of feedbacks is obtained through geolocation.

In some embodiments, the determined one or more responsive feedbacks are further filtered and/or ranked with respect to one or more parameters or user preferences.

In some embodiments, the geographical search area is defined by use preferences preset by the user on the computing device.

In another aspect, a computer-implemented method is provided, which comprises: using a first computing device, a first user creating a first feedback about a first target of interest having a location information while the first user is located at the location of the first target; determining, using the first computing device, the geographical location of the first computing device at the creation of the first feedback as the location of the first feedback; sending the first feedback including the location of the first feedback to a server; at the server, storing the first feedback with the location of the first feedback, as well as the time of receiving the first feedback, in a feedback database; using a second computing device, a second user creating a second feedback about a second target of interest having a location information while the second user is located at the location of the second target, the second target being the same as or different from the first target; determining, using the second computing device, the geographical location of the second computing device at the creation of the second feedback as the location of the second feedback; sending the second feedback including the location of the second feedback to the server; at the server, storing the second feedback with the location of the second feedback, as well as the time of receiving the second feedback, in the feedback database; receiving, a third computing device, a query of a third user to search for feedbacks that have locations falling within a geographical search area defined by the third user and created at a time that meets a recency requirement relative to the time of the query is received; the third computing device sending the user query to the server; using a search engine, and from the feedback database, the server determine one or more feedbacks responsive to the user query; the server sending the one or more responsive feedbacks to the third computing device; and the third computing device displaying the responsive one or more feedbacks on a user interface.

In another aspect, a computer system is provided, which comprises a memory, one or more processors, and computer-readable instructions operative, when executed, to cause the one or more processors to perform the methods described herein.

### BRIEF DESCRIPTION OF THE DRAWINGS

FIG. 1 is an overall diagram of process flow of a system disclosed in accordance with some embodiments of the present invention.

FIG. 2 shows a few different methods that a user can define a search area to be searched for feedbacks in accordance with some embodiments of the present invention.

FIG. 3A is an illustration of an example of creating a user feedback, i.e., making a video about a food served in a restaurant; FIG. 3B is an example screenshot of a feedback containing the feedback title, feedback text and the video made.

FIG. 4 illustrates that several feedbacks each containing a captured video are shown on a map view based on the locations where the videos were captured or posted.

FIG. 5 illustrates a few different users shown on a map view at a given time providing feedback of various categories/types and locations.

FIG. 6 illustrates a feedback search result where a number of responsive feedbacks returned are shown on a map view.

FIGS. 7-9 illustrate certain examples of certain users using the feedback management system as described herein.

FIGS. 10A, 10B and 10C each illustrates a search result of responsive feedbacks shown a map view, a view for the feedback content, and classification of the feedback which can be used as a filter to select a subset of the feedbacks in the search results.

### DETAILED DESCRIPTION

An object of this invention is to allow people to be able to more accurately stay informed with current local happenings via improved methods and systems that manage people's feedbacks on events, activities, points of interests, etc. A user (or provider) can use the disclosed system and methods to post and share their experiences; and another user (or consumer) seeking relevant information can search in a defined geological area to obtain those experiences within the defined area, and make informed decision.

In general, the present invention provides a method and system feedback management. In one aspect, a computer-implemented method is provided, which comprises: providing or obtaining a collection of feedbacks, each feedback including or tagged with a geographical location and a time of creation; receiving, at a computing device (e.g., from a graphical user interface that includes a map view), a user query to search feedbacks having geographical locations falling within a defined geographical search area and having time of creation that meets a recency criteria; determining, using at least one computer processor, one or more feedbacks in the collection of feedbacks that are responsive to the user query; and displaying the determined one or more responsive feedbacks on a user interface of the computing device.

In the above method, the computing device can be a personal computing device such as a mobile smartphone, a tablet, or the like. Preferably the personal computing device is geolocation-enabled in that it has necessary hardware component (e.g., radio hardware for receiving geolocation coordinates from GNSS satellites and interpreting coordinate vector information) and associated software components that allows its geographical location to be actively determined, e.g., by GNSS feedback. The location of the computing device thus obtained can be used as a search parameter in the method (e.g., in the search area defined). The personal computing device can be connected to and in communication with a remote server computing device (or a cloud computing environment including multiple interconnected computers, herein simply referred to as a “server”) which is equipped with hardware and software configured to perform certain actions/operations, e.g., storing the feedbacks provided from different users, performing the search function via a search engine, sending the search results to the personal computer of the user, etc. Thus, not all the steps of the method need to be performed on one computing device. In alternative embodiments such a remote server need not be physically present, and the described server functions can be implemented on any one of the personal computing devices as a software module or simulator which directly communicates with a client mobile App installed on the same device (the “hosting” device). Other personal computing devices with client mobile App installed can communicate with the hosting device through either a data network or directly by Bluetooth or other local communication protocols. This would be useful for when an internet connection is not available. In other embodiments, several users may share one personal computing device or terminal, each user operating on a separate instance of the feedback management application software (each instance acting independently as if on a separate computing device).

A computing device of this disclosure includes a processor, memory, storage, an input/output (I/O) interface, a communication component, and a bus that connects all these components. The server can have a same or substantially similar architecture. Although this disclosure describes and illustrates a particular mobile device having a particular number of particular components in a particular arrangement, this disclosure contemplates any suitable mobile device having any suitable number of any suitable components in any suitable arrangement. The processor can include hardware for executing instructions, such as those making up a computer program or application, for example, it may retrieve (or fetch) the instructions from an internal register, an internal cache, memory, storage; decode and execute them; and then write one or more results to internal register, internal cache, memory, or storage. In particular embodiments, software executed by processor may include an operating system (OS). As an example, and not by limitation, if a personal computing device is a smartphone, then the OS may be a mobile operating system, such as for example, Android, iOS. In some embodiments, the memory can include main memory for storing instructions for the processor to execute or data for processor to operate on. The memory can include random-access memory (RAM). This RAM may be volatile memory, where appropriate. Where appropriate, this RAM may be dynamic RAM (DRAM) or static RAM (SRAM). The storage can include non-volatile and/or non-transient mass storage or media for data or instructions, for example HDD, flash memory, optical medium, DVD, etc., or a combination of two or more thereof, solid-state memory. read-only memory (ROM), or any other suitable physical form. The I/O interface can include hardware, software, or both providing one or more interfaces for communication between the personal computing device and one or more I/O devices, such as keyboard, keypad, one or more sensors, touch screen, microphone, monitor, mouse, printer, scanner, speaker, etc. The communication component can include hardware, software, or both providing one or more interfaces for communication (such as, for example, packet-based communication) between the computing device with the server or other personal computing device(s), for example, a network interface controller (NIC) or network adapter for communicating with an Ethernet or other wire-based network or a wireless NIC (WNIC), wireless adapter for communicating with a wireless network, such as for example a WI-FI network or modem for communicating with a cellular network, such as 4G/5G generation mobile telecommunications, Long Term Evolution (LTE) network, wireless PAN (WPAN) (such as, for example, a BLUETOOTH WPAN), a WI-FI network, a WI-MAX network, or other suitable wireless network or a combination of two or more thereof. The bus can include hardware, software, or both coupling components of the computing device to each other, for example, a graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a serial advanced technology attachment (SATA) bus, a Video Electronics Standards Association local (VLB) bus, or another suitable bus or a combination of two or more of these.

In another further aspect, the present disclosure provide a computer system that includes a computing device in communication with a server computer, the computing device and the server computer comprising a memory, one or more processors, and computer-readable instructions operative, when executed, to cause the one or more processors to perform the method as recited.

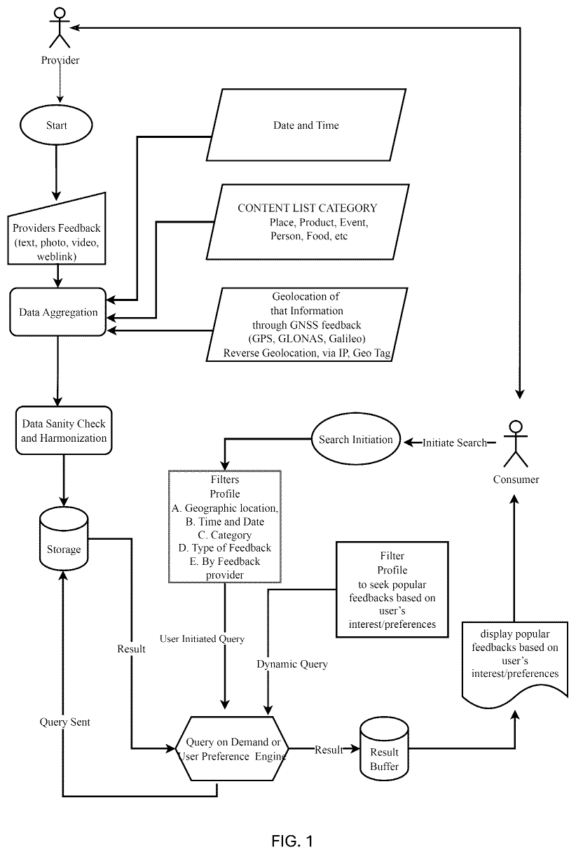

For ease of reference and discussion, the software application software residing on the user computing device for the present disclosure is generally referred to as the feedback management application. The one or more computing devices (including server(s)) that perform the methods described herein, together with the software applications residing on these computing devices, are referred to the “system” or “platform” of the present disclosure. A general summary of the process flow of the platform is shown in FIG. 1.

A feedback as used herein refers to information (such as comments, opinions, graphical information such as a photo or video, etc.) provided by a person (or user) about a target of interest, which can include an object, a person, a service, an event, a place/location, etc., based on his or her own actual observation, experience, and/or interaction of and with the target of interest. The target of interest includes a location dimension which is either inherently associated with the target of interest (such as a point of interest) or the location of an occurrence. In some instances, the target of interest also includes temporal information, such as the time of occurrence of an event or activity. The feedback can be in the form or type of a text, a hyperlink, a video, an image, a sound, or other forms, and any combinations thereof. The feedback itself includes the geographical location information of the target of interest. The location can be preferably determined by geolocation, e.g., by using GPS sensor(s) in the computing device by which the person enters the feedback, cellular localization, or other means, while the person was physically at the target of interest or experiencing/observing/interacting with the target of interest. The geographical location information determined by geolocation can be very accurate, e.g., about 10 meters or less. Alternatively, it can be entered manually by the user who provides the feedback at the time of providing/uploading the feedback. The temporal information of the feedback can be the time when the feed is created or uploaded to the feedback management system. To ensure accuracy and reliability of the information of a feedback entered by a user, it can be validated by either community voting or confirmation from businesses and service providers.

A feedback can be classified into categories and sub-categories based on the target of interest that the feedback concerns. For example, an event is a type of target of interest, and it can have sub-categories of tradeshows, concerts, book fair, parent training, etc. A hospitality establishment or business can also be a type of target of interest, and it can have subcategories of hotels, restaurants, recreation centers, cruise lines, etc. The categories and sub-categories can be pre-defined by the system, and the user feedback can be automatically classified into one or more categories (and subcategories if needed), or the user can manually designate the category/sub-category when he/she is entering the feedback.

Examples of feedbacks include the following: a user enjoyed a food at a restaurant and shared the picture or video of the food with where this is available disclosing the time and location; a user found a sale for a product at a store and share the information, picture of that product and information of that store, location etc. and validity of that sale period; a user enjoyed a beautiful fall foliage view and shared the location of the viewpoint and time. Such feedbacks are stored for later queries and retrievals by other users who seek food options, products on sale and place to visit.

All feedbacks can be stored in a computer database or databases which could be either structured or document based for storing semi structured data as a document-rather than normalizing data across multiple tables, each with a unique and fixed structures.

Preferably, the temporal information of the target of interest, if existing, and that of the feedback should coincide or substantially overlap, indicating a “live” feedback by the person providing the feedback. As an example, if a feedback is provided or uploaded to the system more than a predetermined time period, e.g., 1 hour, 2 hours, 5 hours, 1 day, 2 days, 1 week, etc., after the actual occurrence of the event, the experience, or the observation that is the subject of the feedback, depending on the nature of the of the event, the experience, or the observation that is the subject of the feedback, the feedback can be considered as invalid and excluded in the feedback database. Also, to ensure freshness of the feedbacks, an expiration date for the feedbacks can be set default by the user based on the category or nature of the feedback, e.g., 1 month, 2 months, 6 months, etc., after which time the feedbacks will be deleted from the feedback database, or archived away and excluded from the scope of the searches of feedbacks as described herein.

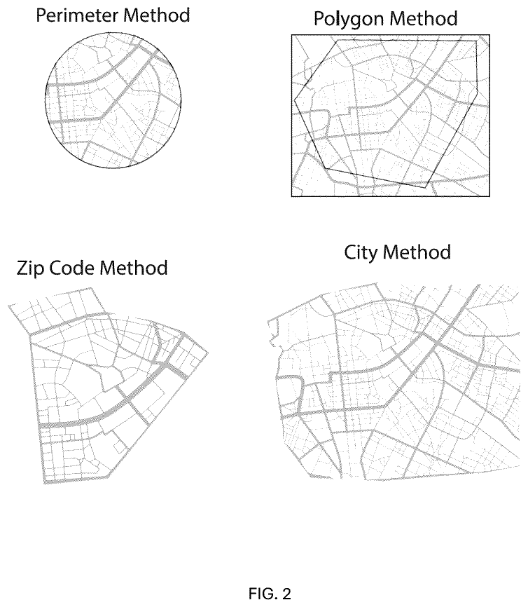

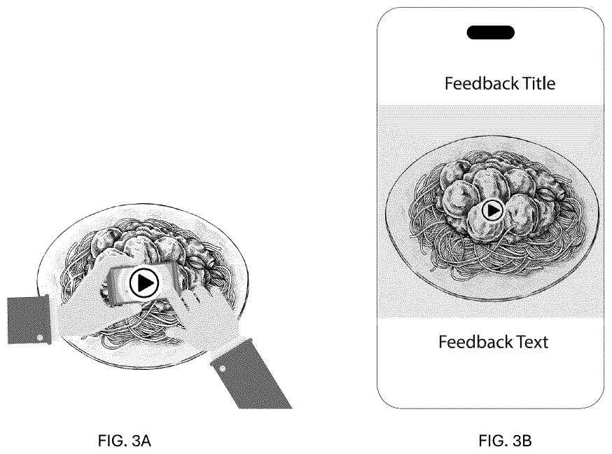

The user computing device has a graphic user interface which preferably includes a map view, e.g., an interactive digital map (e.g., one that resembles the popular Google map, Apple map etc.). The geographical search area can also be selected by the user on the map view. As shown in FIG. 2, the boundary of the search area can be obtained by geofencing based on the current location of the user computing device by a perimeter method (where the user defines a radius of search), a polygon method (where the user defines the periphery of the boundary using a touchscreen input on the map view), a zip code method (based on the zip code in which the user is currently located), a city method ((based on the city in which the user is currently located), which are well known in the art.

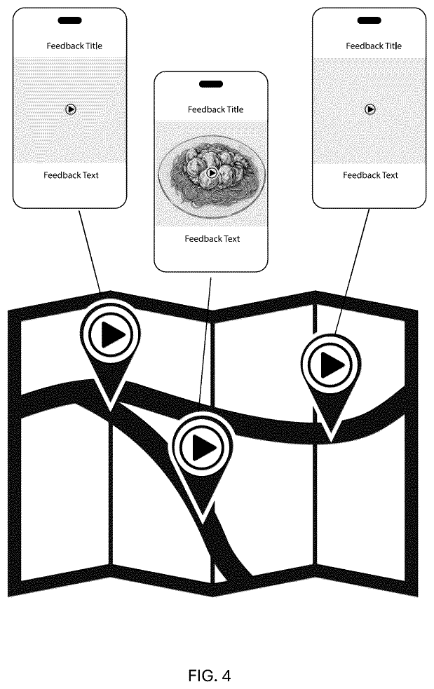

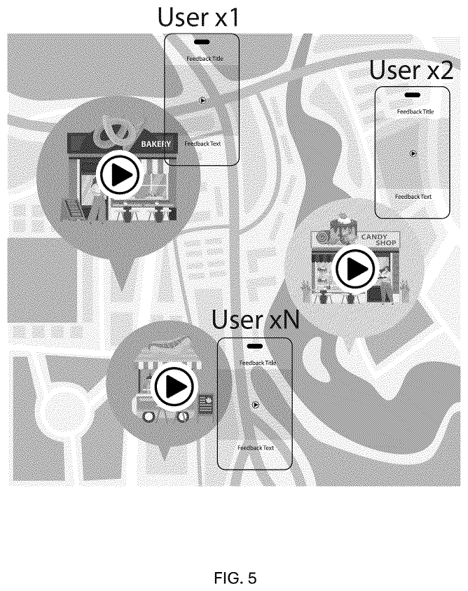

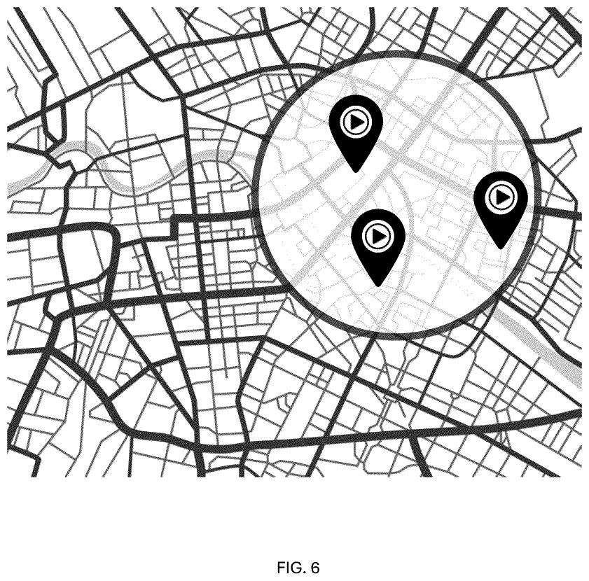

The locations of retrieved feedbacks are preferably displayed on the map view as an icon or symbol (e.g., a pin that is used in popular map apps on mobile phones). Other information of the feedback can also be displayed on the map view as well along with the icons, such as a preview of the video contained in the feedback, an indication that signifies the type of the feedback (e.g., a video), etc., as shown in FIGS. 4-5. Alternatively, or additionally, the retrieved feedbacks can be shown as a list of text or in other forms.

The search can be performed by a search engine that is part of the application software residing on the user computing device or a remote server to which the search query is sent. The search engine can search based on one or more of the parameters of the feedbacks: geographic information, temporal information (time/date of the feedback), classification, type/form, person who provided the feedback, etc. The search engine can further filter or rank the retrieved feedbacks using one or more of these parameters, as well as other parameters such as the distance from the location of the feedback to the current location of the user computing device, the rating or popularity of the feedbacks, etc. Alternatively, these search parameters can be used as filter parameters after an initial search was performed and results returned to further focus the search results based on user input or preferences.

As the temporal information of the feedbacks is a significant factor in evaluating the freshness of the feedbacks, hence the relevance of the feedback, the recency of the feedbacks can be used as one mandatory explicit search parameter, or it can be set as a default search parameter that is always used in a search without an active selection, e.g., saved as a user preference in a user profile. In an example, unless the recency of a feedback is less than a predetermined threshold (e.g., a feedback is less than 1 weed old, 1 month old, etc.) it will be excluded in the search results. Alternatively, a search can be done by the user entering specific time window the temporal information of the feedback falls into, such that only feedbacks entered or created within the specific time window are retrieved as a result of the search.

In some embodiments, the ranking can be performed based on a composite rating computed based on more than one parameter, where different parameters can be assigned a different weighting factor. For example, the recency of the feedback can be included the ranking and assigned with a weighting factor significantly greater than other parameters.

In some embodiments, the search area can also defined by the user by preferences and saved on his/her profile in the application software on his/her computing device, as well as his/her current location which an be determined by geolocation on his/her computing device. In this manner, the user can have a “default” search performed without entering some or any search parameters.

A search can be done automatically in the background by the feedback management application according to a pre-configured search that is triggered by an occurrence without the user intervention. For example, if the user (with his/her personal computing device) enters a geographical area, the search can be automatically performed according to saved search preferences (e.g., search area and/or other parameters of the search) and the search results presented to the user, and the user does not need to enter a query each time. For another example, the system can be configured where users can subscribe to real-time notifications for a search area when a feedback is uploaded that meets the criteria of a pre-configured search occurs in the search area (e.g., the classification (categories), or from select feedback providers.

The software application for implementing the methods herein can adopt an architecture suitable for a social networking community, which includes user account authentication and management function, feedback uploading, data sanity check and harmonization, messaging between users, database management, real-time data streaming and processing, etc. The feedback management system can include components that are integrated with third-party social media platforms and external APIs, allowing users to share feedback across platforms or pull in relevant data to enhance feedback for a given location or experience. The system can further employ machine learning algorithms to personalize user search results based on previous feedback interactions, location history, and preferences.

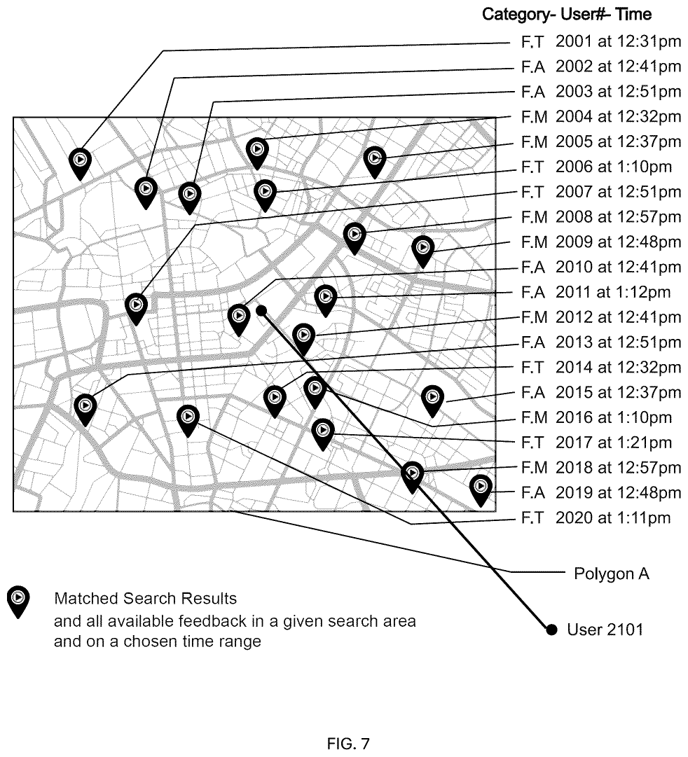

FIGS. 7-10 illustrate certain examples of certain users using the feedback management system as described herein. In FIG. 7, User #2001 through #2020 posts their lunch video experiences at various restaurant on a given day between 12:30 pm and 1:30 pm. User #2101, seeking for lunch at 1:30 pm, set the geofence boundary of a rectangular Polygon A and set the time range as Last One Hour; search result will reveal the video posts of user #2001 through #2020 and would be pinned on a map for their corresponding location and food type e.g. F.T, F.A and F.M. (FT—THAI FOOD, FA—AMERICAN FOOD, FM—MEXICAN FOOD).

User #2101 may view all 20 videos or may decide to narrow down the time range to Last 30 minutes and to narrow down to 10-minute walk distance or 100-meter perimeter around his location. User #2101 may further decide to filter and view only the 5-star ratings videos and narrow down search result accordingly.

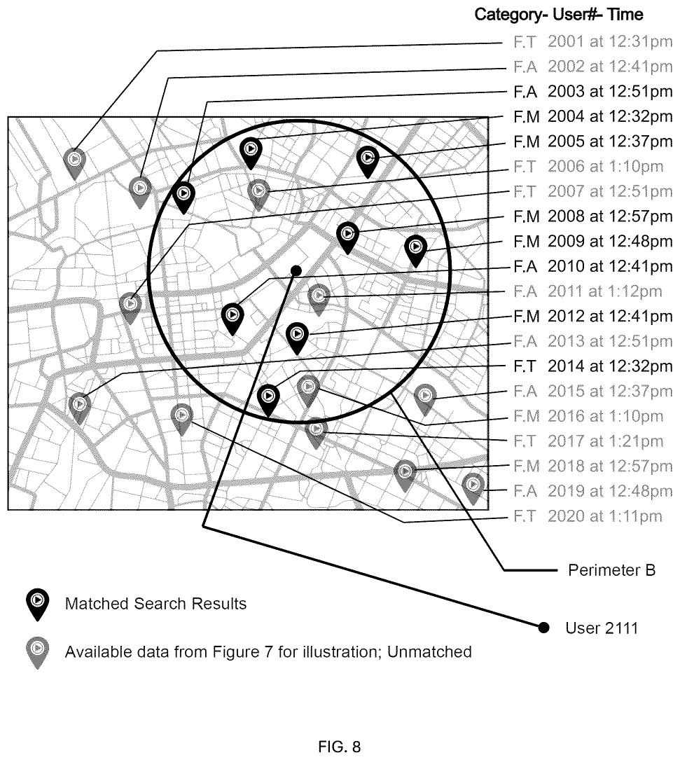

User #2111, on FIG. 8, searched for all available food types F.T, F.A and F.M and set a half-mile radius from his location, shown as Perimeter B, and sets the time range between 12:30 pm and 1:00 pm.

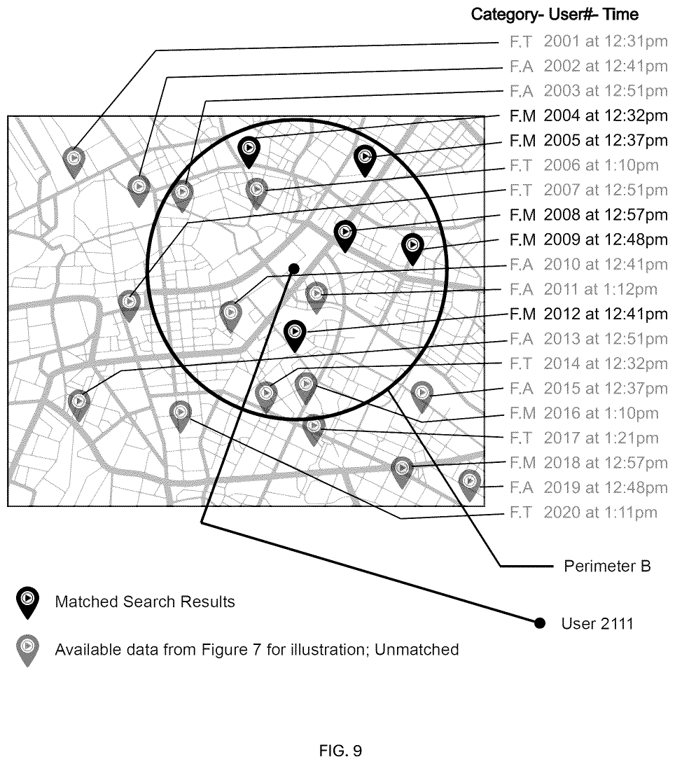

Search result on figure-8 displays the location of matched results for eight (8) users-User #2003, 2004, 2005, 2008, 2009, 2010, 2012 and 2014. User #2111 further narrowed the search for Only F.M. type food category and his search results are shown, on FIG. 9; search narrowed down the list to feedbacks from five (5) users—User #2004, 2005, 2008, 2009 and 2012 only.

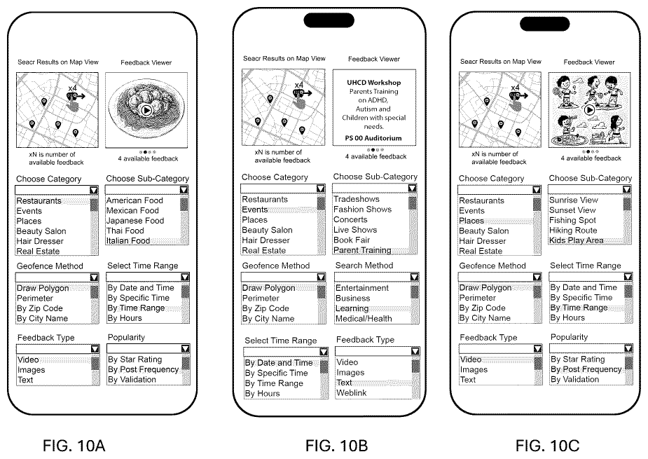

A user, on FIG. 10a, chose search area and filter to list Restaurant as category, Italian food as subcategory, for a time range chose Post Frequency and found 4 available feedback on matched criteria and start viewing the video contents. FIGS. 10b and 10c displays users choose different categories and matched results of Events and Play areas are displayed correspondingly.

This disclosure encompasses all changes, substitutions, variations, alterations, and modifications to the example embodiments herein that a person having ordinary skill in the art would comprehend. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A computer-implemented method comprising:
providing or obtaining a collection of feedbacks, each feedback including or tagged with a geographical location and a time of creation;
receiving, at a computing device, a user query to search feedbacks having geographical locations falling within a defined geographical search area and having time of creation that meets a recency criteria;
determining, using at least one computer processor, one or more feedbacks in the collection of feedbacks that are responsive to the user query; and
displaying the determined one or more responsive feedbacks on a user interface of the computing device.

2. The method of claim 1, wherein the computing device includes a user interface comprising a map view, and wherein the displaying comprises displaying the location information of the one or more determined responsive feedbacks on the map view.

3. The method of claim 1, wherein the computing device includes a user interface comprising a map view, and the geographical search area is selected by the user on the map view.

4. The method of claim 1, wherein the geographical search area is determined based on a current location of the computing device.

5. The method of claim 1, wherein the determining further comprises ranking the one or more responsive feedbacks.

6. The method of claim 1, where in the location of each feedback of the collection of feedbacks is obtained through geolocation.

7. The method of claim 1, wherein the computing device is geolocation-enabled.

8. The method of claim 1, wherein the search area is defined by use preferences preset by the user on the computing device.

9. The method of claim 1, further comprising filtering the determined one or more feedbacks according to preset user preferences.

10. A computer-implemented method comprising:
using a first computing device, a first user creating a first feedback about a first target of interest having a location information while the first user is located at the location of the first target;
determining, using the first computing device, the geographical location of the first computing device at the creation of the first feedback as the location of the first feedback;
sending the first feedback including the location of the first feedback to a server;
at the server, storing the first feedback with the location of the first feedback, as well as the time of receiving the first feedback, in a feedback database;
using a second computing device, a second user creating a second feedback about a second target of interest having a location information while the second user is located at the location of the second target, the second target being the same as or different from the first target;
determining, using the second computing device, the geographical location of the second computing device at the creation of the second feedback as the location of the second feedback;
sending the second feedback including the location of the second feedback to the server;
at the server, storing the second feedback with the location of the second feedback, as well as the time of receiving the second feedback, in the feedback database;
receiving, a third computing device, a query of a third user to search for feedbacks that have locations falling within a geographical search area defined by the third user and created at a time that meets a recency requirement relative to the time of the query is received;
the third computing device sending the user query to the server;
using a search engine, and from the feedback database, the server determining one or more feedbacks responsive to the user query;
the server sending the one or more responsive feedbacks to the third computing device; and the third computing device displaying the responsive one or more feedbacks on a user interface.

11. A computer system comprising a memory, one or more processors, and computer-readable instructions operative, when executed, to cause the one or more processors to:
provide or obtain a collection of feedbacks, each feedback including or tagged with a geographical location and a time of creation;
receive, at a computing device, a user query to search feedbacks having geographical locations falling within a defined geographical search area and having time of creation that meets a recency criterion;
determine, one or more feedbacks in the collection of feedbacks that are responsive to the user query; and
display the determined one or more responsive feedbacks on a user interface of the computing device.
